(19) United States
(12) Patent Application Publication
(10) Pub. No.: US 2010/0160182 A1
(43) Pub. Date: Jun. 24, 2010

(54) Metal Ion-Based Immobilization

(75) Inventors: Chad A. Mirkin, Wilmette, IL (US); Rafael A. Vega, Evanston, IL (US); Daniel Maspoch, Bellaterra (ES); Clifton Kwang-Fu Shen, Evanston, IL (US); Joseph J. Kakkassery, Evanston, IL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Northwestern University, Evanston, IL (US)

(21) Appl. No.: 11/917,415

(22) PCT Filed: Jun. 13, 2006
(86) PCT No.: PCT/US2006/022929

§ 371 Date: Mar. 12, 2010

Related U.S. Application Data
(60) Provisional application No. 60/689,828, filed on Jun. 13, 2005.

(51) Int. Cl. C40B 40/00; C40B 50/18; C40B 40/10; C40B 40/12

(52) U.S. Cl. 506/18; 506/32; 506/13; 506/19

(57) ABSTRACT

A method for immobilizing unmodified material using a metal-ion approach is provided wherein the material is immobilized on a surface in an active state on surface features coupled with metal-ions.

Certain of the studies described in the present application were conducted with the support of government funding in the form of a grant from the National Institutes of Health, Grant No. 1DP1OD000S85-01 and the Air force Office of Scientific Research Grant. No. AFOSR MURI F49620-00-1-0283.

### TECHNICAL FIELD

The invention relates to materials and methods for immobilizing unmodified materials on a surface in an active orientation through metal ion affinity binding.

### BACKGROUND

In the post-genomic era, surface-based proteomics tools in high-throughput formats are becoming crucial for analyzing protein expression, protein-protein interactions, signal transduction pathways, and processes underlying cellular functions (Zhu, et al., Chem. Biol. (2003) 7:55-63). Protein micro- and nanoarrays hold great promise in areas of health-related research (Robinson, et al., Nat. Med. (2002) 8:295-301), drug discovery (Drug Disc. Today (2005) 10:503-511) and diagnostics in which well-defined features and their spacing are important for studying surface-cellular interactions (Chen, et al, Science (1997) 276:1425-1428) and detecting biomacromolecules (MacBeath, S. L. Schreiber, Science 2000, 289, 1760-1763).

Thus far, a variety of techniques have been developed for immobilizing proteins, specifically antibodies, on surfaces. These techniques have relied primarily on antibody binding proteins (protein A, G, A/G and L) (Lynch, et al., Proteomics (2004) 4:1695-1702, Lu, et al., Analyst (1996) 121:19R-32R), genetic and/or chemical engineering technologies to produce unnatural binding tags for directed surface attachment (Peluso, et al., Anal. Biochem. (2003) 312:113-123), electrostatically driven adsorption (Lee, et al., Science 2002, 195, 1702-1705, Wang, et al., Langmuir 2004, 20, 1877-1887), covalent linking (MacBeath, supra, G. T. Hermanson, Bioconjugate Techniques, Academic Press, San Diego, Calif., 1995), or a combination thereof (Ramachandran, et al., Science 2004, 305, 86-90). Although these approaches have been widely used, they have drawbacks ranging from cost and complexity to inactivation of the antibody structures due to denaturation which leads to poor antigen binding (Miller, et al., Microarray Technology and Its Applications, Springer, N.Y., 2005), or poor orientation control. At present, a universal methodology for controlling the immobilization, orientation, and activity of surface-anchored functional biological species, and in particular antibodies, does not exist

In still other approaches, immobilizing of antibodies with metal ions (i.e. Zn(II), Cu(II), Ni(II), Co(II)) on three dimensional chromatographic supports has been reported (Porath, et al., Nature 1975, 258, 598-599, Hale, Anal. Biochem. 1995, 231, 46-49, Todorova-Balvay, et al., J. Chromatogr. B 2004, 808, 57-62, Hale, et al., Anal. Biochem. 1994, 222, 29-34). Likewise, researchers have utilized direct-write techniques, such as robotic spotting (Miller, supra) and Dip-Pen Nanolithography (DPN) (Piner, et al., Science 1999, 283, 661-663), in combination with metal ions as linking groups to generate oligonucleotide (Bujoli, et al., Chem. Eur. J., 2005, 11, 1980-1988) and virus particle (Vega, et al., Angew. Chem. 2005, 177, 6167-6169; Angew. Chem. Int. Ed. 2005, 44, 6013-6015) micro-/nanoarrays.

The method currently used to immobilize larger biological species such as viruses on a surface employs genetic modification of viruses to express surface proteins that can then be used for covalent anchoring (Cheung, et al., J. Am. Chem. Soc. (2003) 125:6848, Smith, et la., Nano Lett. (2003) 3:883). However, this method has a major drawback due to the fact that not all virus particles can be modified easily while maintaining their original biological activity.

Thus there exists a need in the art to develop materials and methods that can be used to immobilize materials, including biological species, that are relatively inexpensive, easier to use and provide immobilization of the species in a desired orientation.

### SUMMARY OF THE INVENTION

In one embodiment, methods of immobilizing a material on a surface are provided, the material having a metal ion binding site, the surface having a plurality of coordination sites and a metal ion positioned on said coordination sites, the method comprising the step of contacting the material with the surface under conditions that permit the metal ion binding site on the material to associate with the metal ion on the surface. In one aspect the material is an unmodified biological species selected from the group consisting of a protein, a polypeptide, a polysaccharide, a cell, a bacterium, a virus, a mold, and a fungus. In another aspect, the metal ion binding site on the material comprises carboxylate groups and/or imidazole groups. In another aspect, the metal ion is a divalent metal ion, and in various embodiments, the divalent cation is selected from the group consisting of zinc, copper, nickel, cobalt, iron, and manganese. In other aspect, the metal is selected from the group consisting of titanium and zirconium. In still another aspect, the cell, bacterium or virus immobilized on said surface is viable.

In still another aspect, the protein or polypeptide comprises an imidazole-rich region of an antibody Fc region, and/or an carboxylate-rich region. In various embodiments, the protein is an antibody comprising and F_{c} region and an F_{ab} region, and the antibody is immobilized on said surface predominantly oriented such that said F_{c} region is coordinately bound to said surface and said F_{ab} portion is disposed away from said surface. The antibody in one aspects is a chimeric antibody. The protein, in one aspect, is a fusion protein comprising all or part of an antibody Fc domain and binding partner protein, and in another aspect, the protein comprises a metal binding motif.

In still other aspects, methods are provide wherein the surface is a thin film, a nanoparticle, or a nanoparticle on an otherwise inert surface. In one aspect, the surface overlays a substrate.

Methods are also provided wherein the surface is patterned to control position at which the metal ion is coordinated, and in various aspects, the surface is patterned using Dip-Pen Nanolithography or using micro-contact printing. Methods are also provided wherein portions of the surface comprising coordination sites are defined by patterning, and wherein a chemical entity comprising one or more coordination sites is deposited on the surface in a spatially defined manner by means of Dip-Pen Nanolithography (DPN). In one aspect, a fraction of the coordination sites on the surface are masked or deactivated in a spatially defined manner by the use of Dip-Pen Nanolithography (DPN) to deposit a masking or deactivating agent on said surface such that said agent contacts said fraction of the coordination sites.

Methods are also provided wherein the surface is patterned with an alkanethiol, and in various aspect, the alkanethiol comprises functional group selected from the group consisting of a carboxylic acid, a phosphate, a sulfur or a nitrogen. In one embodiments, the surface is patterned with 16-mercaptohexadecanoic acid (MHA).

Methods are also provided wherein the metal ion is coordinated on the patterned surface in an array.

In still other aspects, methods are provided wherein the surface is passivated, and in one aspect, the surface is passivated with an alkanethiol. In other aspects, the alkanethiol is a poly- or oligoethylene glycol thiol, and in one embodiment, the alkanethiol is 11-mercaptoundecyl-penta(ethylene glycol) (PEG-SH).

Methods are also provided wherein said surface is a gold thin film on a substrate, and in various embodiments, the substrate is silicon or glass, or a silicon wafer or glass slide.

In one aspect, methods are provided wherein coordination sites of the surface are intrinsically present, and in another aspect, coordination sites are introduced into the surface.

In another embodiment, a surface is provided having a plurality of coordination sites, a metal ion positioned on the coordination sites, and an unmodified material associated with the metal ion. In various aspects, the surface include material which is an unmodified biological species selected from the group consisting of a protein, a polypeptide, a polysaccharide, a cell, a bacterium, a virus, a mold, and a fungus. In other aspects, the a metal ion binding site on the material comprises carboxylate groups or imidazole groups. In one aspect, metal ion is a divalent metal ion, and in various embodiments, the divalent cation is selected from the group consisting of zinc, copper, nickel, cobalt, iron, and manganese. In another aspect, metal ion is selected from the group consisting of titanium and zirconium.

A surface is also provided wherein the cell, bacterium or virus immobilized on said surface is viable.

In another aspect, the surface includes an immobilized protein or polypeptide comprising an imidazoles-rich region of an antibody F_{c} region and/or a carboylate-rich region. In one aspect, the protein is an antibody comprising and F_{c} region and an F_{ab} region, and in one embodiments, the antibody is immobilized on said surface predominantly oriented such that said F_{c} region is coordinately bound to said surface and said F_{ab} portion is disposed away from said surface. In another aspect, the protein is a chimeric antibody or a fusion protein comprising all or part of an antibody Fc domain and binding partner protein. In one aspect, the protein comprises a metal binding motif.

A surface is also provided which is a thin film, a nanoparticle, or a nanoparticle on an otherwise inert surface.

In one aspect, the surface overlays a substrate.

In another aspect, the surface is patterned to control metal ion coordination, and in various embodiments, the surface is patterned using Dip-Pen Nanolithography or using micro-contact printing.

A surface is also provided wherein portions of said surface comprising coordination sites are defined by patterning. In another aspect, the surface includes a chemical entity comprising one or more coordination sites is deposited on the surface in a spatially defined manner by means of Dip-Pen Nanolithography (DPN). In another embodiments, the surface includes a fraction of the coordination sites which are masked or deactivated in a spatially defined manner by the use of Dip-Pen Nanolithography (DPN) to deposit a masking or deactivating agent on said surface such that said agent contacts said fraction of the coordination sites.

In one aspect, the surface is patterned with an alkanethiol, and in various embodiments, the alkanethiol comprises functional group selected from the group consisting of a carboxylic acid, a phosphate, a sulfur or a nitrogen. In one aspect, the surface is patterned with 16-mercaptohexadecanoic acid (MHA).

A surface is also provided wherein the metal ion is coordinated on said patterned surface in an array.

A surface is also provided which is passivated, and in one aspect, the surface is passivated with an alkanethiol. In various embodiments, the alkanethiol is a poly- or oligoethylene glycol thiol, and in another aspect, the alkanethiol is 11-mercaptoundecyl-penta(ethylene glycol) (PEG-SH).

A surface which is a gold thin film on a substrate is also provided, and in various aspects, substrate is silicon or glass, or a silicon wafer or glass slide.

In still other aspects, a surface is provided wherein coordination sites of said surface are intrinsically present or the coordination sites are introduced into the surface.

In another embodiment, a kit is provided comprising a surface provided herein.

It will be understood that methods and surface products provided include each of the various aspects and embodiments individually or in all combinations disclosed herein.

### DESCRIPTION OF THE DRAWINGS

FIG. 1. PM-IRRAS spectra of a monolayer of MHA on Au, after treatment with Zn(NO₃)₂.6H₂O and after incubation with anti-Udorn (goat IgG). Top spectrum shows the infrared spectrum of the binding of anti-Udorn on a MHA monolayer surface, in the absence of Zn(II).

FIG. 2. Positive ion ToF-SIMS images of (a) MHA-Zn(II) and (b) MHA-Zn(II)-anti-Udorn microarrays generated by μ-CP. The green areas corresponds to Zn metal ion (m/z=64.015) and the red areas are most characteristic of PEG-SH (m/z=45.068). ToF-SIMS analysis was carried out using a PHI TRIFT III (Physical Electronics., Chanhassen, Minn.). Positive ion images were acquired with a pulsed, unbunched 25 KeV primary ion beam at 600 pA by rastering the ion beam over a 10 μm×10 μm sample area. The primary ion dose was kept below 1013 ions/cm2. Charge compensation was achieved by using a pulsed, low-energy electron flood gun. The data were acquired in raw data stream mode. Positive data were calibrated to CH₃⁺ (15.023 m/z), C₂H₃⁺ (27.023 m/z), and C₃H₅⁺ (41.039 m/z).

FIG. 3. a) TM-AFM topography image and height profiles of anti-Udorn (polyclonal goat IgG) immobilized on 500 nm MHA dot arrays pretreated with Zn (NO₃)₂.6H₂O. b) TM-AFM topography image and height profile of the anti-Udorn nanoarray after the addition and binding of the influenza virus. All AFM images were taken at the same location (with zoomed in 3D topographical insets) at a scan rate of 0.5 Hz (silicon cantilever, spring constant=40 N m⁻¹). Scale bars are 1 μm for the large arrays.

FIG. 4. Anti-HA (mouse IgG1) and anti-Udorn (goat IgG) microarrays. a) Fluorescence image of Alexa Fluor 596-labeled anti-HA (mouse IgG1, Covance Inc., Berkley, Calif.). b) TM-AFM image and height profiles of an antibody microarray (anti-Udorn) formed on an array of 1.5 μm MHA dot features obtained by μ-CP, pretreated with Zn(NO₂)₃.6H₂O. c) Antibody microarray after treatment with influenza viruses. Multiple influenza virus particles are bound to each feature. The insets show enlarged topographic images of 2×2 dot arrays. Scale bars are 2 μm for the large arrays and 2 μm for the insets. Images were taken at a scan rate of 0.5 Hz.

FIG. 5. High resolution TM-AFM image of an influenza virus particle imaged under ambient conditions. a) AFM tapping mode topography image and height profile of an influenza virus particle exhibiting a diameter of 175 nm and height of 26.5 nm. The observed difference in dimensions of a single virus particle compared to those determined by electron microscopy [see R. A. Lamb, R. M. Krug, In Fields Virology 4th edn (eds B. N. Fields, D. M. Knipe, P. M. Howley) Ch. 46 (Lippincott-Raven, Philadelphia, 2001)] may be attributed to the difference in the imaging conditions. b) Phase image of the same virus. The phase lag is 1.5o. Images were taken at a scan rate of 0.3 Hz.

FIG. 6. TM-AFM topography image and height profile of anti-SV5 on a Zn(II)-free MHA nanoarray after the addition of SV5 particles (note the low percentage of SV5 on the features). The inset of the AFM image shows an enlarged topographic image of a 3×3 dot array. Scale bars are 1 μm for the large arrays and 500 nm for the insets. The images were taken at a scan rate of 0.5 Hz.

FIG. 7. Fluorescence images showing the successful binding of Alexa Fluor 488-labeled goat anti-mouse (secondary antibody) to array features treated with (a) and without (b) influenza virus particles sandwiched with anti-HA (mouse IgG) on anti-Udorn (goat IgG) nanoarrays immobilized with Zn(II)-MHA affinity templates. c) TM-AFM image confirms the binding of the secondary antibody to the sandwiched virus particles. The scale bars on the fluorescence and AFM images are 2.5 μm for the array and 500 nm for the insert. AFM images were taken at a scan rate of 0.5 Hz.

FIG. 8. AFM tapping mode images and height profiles of antibody nanoarrays immobilized with Zn(II) affinity templates before and after treatment with complementary virus or protein antigens. Anti-HA (chicken IgY) nanoarray before (a) and after (b) treatment with influenza virus. Anti-SV5 (rabbit IgG) nanoarray before (c) and after (d) the addition of paramyxovirus SV5. Anti-ER-(3 (mouse IgM) nanoarray before (e) and after (f) addition of a recombinant long form of ER-13. Anti-p24 (mouse IgG1) nanoarray TM-AFM image before (g) and fluorescent image after (h) addition of recombinant p24 (HIV-1)-FITC. The scale bars on the AFM images are 1.5 μm for the large arrays and 500 nm for the insets. AFM images were taken at a scan rate of 0.5 Hz.

FIG. 9. a) TM-AFM image of the anti-SV5 on a Zn(II)-MHA nanoarray after the addition of the TMV (note the lack of TMV on the features). b) TM-AFM image of the anti-SV5 on a Zn(II)-MHA nanoarray after the addition of a mixture of SV5/TMV (1:1). The insets of all AFM images show enlarged topographic images of 3×3 dot arrays. Scale bars of AFM images are 1.5 μm for the large arrays and 500 nm for the insets. Images were taken at a scan rate of 0.5 Hz.

FIG. 10. TM-AFM topography images and height profiles of an array of (a) protein A/G covalently attached onto an NHS (0.2M)/EDAC (0.1M) treated surface used to crosslink the MHA-patterned areas [see S. Rozhok et al., Small, 2005, 1, 445-451], (b) followed by the addition of anti-Udorn (goat IgG). c) The immobilized antibody array was then treated with a solution of influenza virus particles. The height of protein A/G features, antibodies immobilized via protein A/G, and captured virus particles are 2.8±0.5 nm, 10.2±1.3 nm, and 30.8±1.6 nm, respectively. The insets of all AFM images show enlarged topographic images of 2×2 dot arrays. Scale bars are 1 μm for the large arrays and 500 nm for the insets. The images were taken at a scan rate of 0.5 Hz.

FIG. 11: Tapping mode AFM (silicon cantilever, spring constant=ca 40 N/m) image and height profile of μ-CP dots (1.5 μM diameter) containing (A) anti-Udorn array (B) after incubation with influenza A virus and (C) after antibody sandwich complexation (with anti-Udorn) on Zn²⁺-MHA modified surfaces. (D) anti-Udorn array and (E) after incubation with influenza A virus on MHA modified surfaces in the absence of Zn²⁺. The image was taken at a scan rate of 0.5 Hz.

FIG. 12: Tapping mode AFM (silicon cantilever, spring constant=ca 40 N/m) image and height profile of (A) bulk gold thin film sample (7.5 cm×2.5 cm) containing a monolayer of TMV on a Zn²⁺-MHA modified surface. (B) Control experiment exhibits no viral immobilization on 1.5 μm circular features of MHA generated by μ-CP. The image was taken at a scan rate of 0.5 Hz.

FIG. 13: AFM tapping mode (silicon cantilever, spring constant=ca 40 N/m) image and height profile of μ-CP dots (1.5 μm diameter) containing (A) the Influenza A virus on a Zn²⁺-MHA modified array. (B) MHA exposed to Influenza virus in the absence of Zn⁺². The image was taken at a scan rate of 0.5 Hz.

FIG. 14: (A) Optical microscopy image and (B) fluorescence image (actin cytoskeleton: stained with Alexa Fluor 488-conjugated phalloidin (green); cell nucleus: stained with 4,6-diamidino-2-phenylindole (DAPI) (blue)) of MDCK cells adhered to a Zn²⁺-MHA patterned surface.

### DETAILED DESCRIPTION OF THE INVENTION

Methods are provided to immobilize materials on a surface without modification to the species. Methods provided utilize metal ions to immobilize unmodified materials in an orientation that preserves the biorecognition properties of the species. Thus, the methods utilize metal ions as a versatile linker to immobilize materials on surfaces in an active state. In one aspect, use of nanoarrays is instructive in that it provides a “litmus-like test” for evaluating the activity of surface immobilized species. The reduced spot area in a nanoarray demands efficient and relatively uniform immobilization of, for example, antibody structures in active states to exhibit uniform activity from spot to spot within the array. With larger features, such as those found in microarrays, inefficient immobilization (i.e. smaller percentage of active species) still leads to apparent uniform activity from feature to feature within the array.

Methods provided utilize the coordination bonding between surface-immobilized metal ions and the carboxylate and/or imidazole-rich regions in a material. For example, the F_{c} region of an antibody contains an innate histidine-rich sequence that has been suggested to be responsible for the binding of antibodies to metal-loaded IDA resins and to be well-conserved in many different species and subclasses of antibodies (Hale, et al., Anal. Biochem. (1994) 222:29-34; Todorova-Balvay, et al., J. Chromatogr. B., (2004) 808:57-62). Due to the high affinity between antibodies and metal ions, the corresponding antibody density on a metal ion-immobilized surface is equal to that of harnessing conventional immobilization methods using protein A, G, A/G, or L. This high affinity and the ability for metal ions to bind the F_{c} portion of antibodies provides a way of controlling the orientation of antibodies, allowing the exposed F_{ab} regions to bind specifically to the target (i.e. virus, antigen, etc.) with a higher efficiency compared to the randomly orientated or less dense antibody arrays obtained by current methods. Moreover, the methods provided utilize surface chemistry that is inherent to virus and/or cellular surface proteins for immobilization. The metal ions can strongly interact with the active sites present in the surface proteins and immobilize them without compromising the biological activity.

Methods provided are useful in numerous applications including, for example protein chips for proteomic analysis, 2D or 3D crystalline arrays for determination of protein structure, and can be viewed as a replacement to existing commercial biological-based protein-affinity surface, such as that of Enzyme-Linked Immunosorbent Assay (ELISA) where the orientation of the antibody is crucial for biosensing and diagnostics. The methods also allow for controlling the orientation of antibodies on nanoparticle probes for targeted delivery and biosensing.

In addition, methods are contemplated for use of this kind of metallated coating on the surface of artificial implants by which stable cellular attachment is required for long-term tissue-material integration and suppressing immune response. During the last several decades, man-made materials and devices have been developed to the point at which they can be used successfully to replace parts of living systems in the human body. One of the challenges facing the artificial implantation is the biocompatibility of these materials and devices with the human tissues. Most of the implants currently in use are made of titanium, cobalt chromium alloy, or ceramic materials. When an implant is placed in the human body, tissue reacts to the implant surface in a variety of ways depending on the material type. Therefore, the mechanism of tissue attachment as well as life time of the implant depends on the tissue response to the implant_surface. Accordingly, in one embodiment, methods are provided for producing an implant comprising cells immobilized on a surface, wherein the cells are immobilized through interaction between one or more proteins extracellular proteins and a metal ion coordinated on the surface. Other aspects for producing an implant provided will become apparent from the disclosure herein.

The methods provided, and the materials used in practice of the methods, offer advantages over existing technologies in that they are highly economical and robust over current methods that utilize expensive and unstable proteins and protocols to bind, for example, the F_{c} region of an antibody. The present methods eliminate the need to modify or engineer proteins to express specific binding moieties, because the metal ion takes advantage of the inherent protein structure of, for example, the antibodies and coordinates to the imidazole-rich groups already present in their F_{c} regions. In addition, metal ion immobilization is universal to all antibodies containing F_{c} regions regardless of what animal was used to raise the antibodies, whereas proteins A, G, A/G, and L are specific to a select few (Miller, et al., (Ed.), Microarray Technology and Its Applications; Springer: N.Y., 2005). Moreover, metal ions used for immobilization will not degrade and have long storage times, whereas proteins need to be kept in special conditions and will possibly denature over a short period of time upon attachment to the surface.

Accordingly, a straightforward and versatile methodology is provided for immobilizing materials which can be coordinated in an active position through metal ion binding. The methods utilize metal coordination complexes as universal linkers to immobilize materials. By way of example, in the case of antibodies, preferential binding through the F_{c} regions is effected, leaving the antigenic F_{ab} regions exposed to solution. The method is based on two theories. The first is the difference between the isoelectric points (pI) of the antibody fragments. Generally, it has been found that the pIs of the F_{ab} and F_{c} regions are higher and lower, respectively, than the antibody as a single entity. At the pI that the F_{c} and F_{ab} regions are negatively and positively charged, respectively, the difference in charge is the greatest. Thus, by working at pH values near this pI (Zhou, et al., J. Chem. Phys. (2004) 121:1050-1057), functional groups in the F_{c} region can act as ligands and bind metal ions. (Todorova-Balvay, et al., J. Chromatogr. (2004) 808:57-92).

The second theory is that the F_{c} region of an antibody contains an innate histidine-rich sequence that has been suggested to be responsible for the metal-binding. The methods thus allow immobilization of many biological species that can be immobilized in an active form with protein A, G, A/G, or L (Lynch, et al., supra), and even allows one to immobilize antibodies (e.g. chicken IgY and mouse IgM) that generally have a low affinity for protein A, G, A/G. or L.

Even though the methods are exemplified above with antibody immobilization, the worker of ordinary skill will readily appreciate that the methods can be extended for use with other metal-binding materials, such as, for example, proteins, viruses and cells, on a surface without any type of modification to a moiety on the biological species through which metal ion binding occurs. Moreover, the methods are readily extended for immobilizing “non-biological” species which have one or more metal ion binding properties for which immobilization in a specific orientation is desired. “Non-biological species” include without limitation synthetic compounds and/or structures as well as inorganic compounds, each of which including a metal ion binding moiety making the species amendable to immobilization through metal ion binding on a surface as described herein.

### I. Biological Species

The term “biological species” refers to any organic compound, whole or in part, which includes or expresses a moiety rich in imidazoles and/or carboxylic acids. For example, a protein amendable for use in the methods provided includes a region comprising a region relatively high in imidazoles and/or carboxylic acid containing amino acid residues, compared to other regions in the protein. As another example, cells and viruses are used in the methods which include extracellular or outer coat, respectively, proteins also rich in carboxylic acid containing amino acid residues. The worker of ordinary skill in the art will appreciate that there exist other compounds, including for example small molecules which include a region rich in imidazoles and/or carboxylic acid moieties which make these other compounds useful in the methods provided. In the context of proteins, either isolated species or those on the surface or a cell or a virus, metal ion binding through a carbohydrate moiety of a glycoprotein is also contemplated for use in the methods.

As discussed herein, the methods provided are advantageous over methods in the art in that a biological species need not be modified in order to immobilize it on a surface. This is not to say, however, that modified biological species are excluded from the scope of the methods and products provided. The advantage provided is that modified species useful in the methods are not modified for the purpose of allowing immobilization; the modified species is useful in itself without the need to either remove the modification or revert the modified species to its original form. For example, it is known in the art that histidine tags are often incorporated into recombinantly expressed proteins for the purpose of facilitated isolation of the protein using nickel chelation. The histidine tag, however, serves the specific purpose of nickel binding and may alter one or more properties of the protein into which it is incorporated, thereby requiring its removal before, for example, therapeutic administration. On the other hand, a fusion protein as described below comprising a peptide and an antibody F_{c} region is, in general, expressed as this type of fusion not for purposes of its metal binding/isolation properties, but instead for changes in the biological properties conferred on the peptide resulting from fusion to the F_{c} moiety such as, for example, increased circulating half life.

Accordingly, an “unmodified” biological species is one that has not been modified for the sole purpose of immobilizing the species.

### A. Proteins

In one embodiment, methods provided are used to immobilize proteins. Proteins which are easily immobilized include those which have distinct moieties wherein at least one moiety is imidazole/carboxylate rich. Proteins include naturally-occurring proteins, i.e., proteins that can be found in nature, synthetic proteins, i.e., proteins that are not found in nature, proteins that are partially naturally-occurring and partially synthetic, and fragments of each.

### 1. Antibodies

Antibodies provide an aspect of this embodiment by which other proteins amenable to immobilization by the methods provided are identified. As discussed herein, antibodies comprise an F_{c} region, or moiety, which is imidazole/carboxylate-rich compared to the F_{ab} antibody moiety. Thus, also as discussed, interaction of the F_{c} region with an immobilized metal ion positions the immobilized antibody with the antigen binding F_{ab} region in an orientation that allows functional antigen binding.

Accordingly, methods include immobilization of polyclonal antibodies, monoclonal antibodies and derivatives thereof including for example and without limitation chimeric antibodies, humanized antibodies, single chain antibodies, bi- or multispecific antibodies, and chelating recombinant antibodies. It is intuitive that other antibody derivatives are useful in the methods. For example, immobilization of synthetic antibodies is contemplated, including, for example and without limitation, substitution, addition, and deletion variants that maintain metal ion binding capacity through F_{c} region interaction. It is understood in the art that a substitution derivative is one which included one or more amino acid substitutions, an addition derivation is one that includes deletion of one or more amino acid residues and a deletion derivation is one that includes deletion of one or more amino acid residues.

Still other antibody derivatives include antibody fusion proteins comprising an F_{c} region and additional amino acid sequences, the additional amino acid sequence having a protein binding property. Such antibody fusion proteins are, in one aspect, produced by deletion of one or more antibody amino acid residues and addition of one or more other amino acid residues. For example and without limitation, a “chimeric” antibody includes all or part of an F_{c} region from one antibody and all or part of an antigen binding F_{ab} region from a second antibody. As another example, an antibody fusion protein includes all or part of an antibody F_{c} region and amino acids from any source which binds a binding partner, possesses enzymatic activity or possesses any other biological property or activity. Accordingly, additional amino acids, and sequences comprising them, are naturally-occurring or synthetic, a full length protein, a protein fragment, a peptide and/or a derivative thereof as described above.

### 2. Metal Binding Proteins

Still other biological species contemplated for use in the methods provided include metal binding proteins which interact with a metal ion in such a manner that the protein immobilized on a surface through metal ion binding maintains the ability to interact with a binding partner, including an antibody. All derivatives of metal binding proteins as exemplified in the discussion of antibodies above are contemplated as well. In one aspect, the metal binding site, or the moiety in or on which it is located, is distal to the binding partner binding site or moiety.

Metal binding proteins amenable for use in the methods provided are well known in the art and are designated 1.10.220.10 in the CATH protein structure classification. The “metalloproteome” is defined as the set of proteins that have metal-binding capacity by being metalloproteins or having metal-binding sites. A different metalloproteome may exist for each metal.

### B. Cells/Viruses

In another aspect, a metal binding protein need not include a binding partner site or moiety when the metal binding protein is expressed on the surface of a cell or exposed on a virus coat. In this aspect, the metal binding protein need have at minimum the metal binding site exposed and need not include any other moiety with a relatively lower number of imidazoles/carboxylates. Metal binding proteins of this aspect are useful in methods that produce biological implants as disclosed herein. The term “cells” embraces eukaryotic cells, prokaryotic cells, fungal cells, and recombinantly engineered derivatives thereof. The term “virus” embraces virulent strains, strains with attenuated virulence and strains which completely lack virulence (e.g., virus-like particles). The term “virus” also embraces bacteriophage as well.

### II. Metal Ions

As discussed above, the biological species is immobilized on the surface through interaction with one or more metal ions coordinated on the surface. Any of a number of metal ions may be utilized in the methods provided to the extent that each can be coordinated on a surface through functional groups on the surface and each can bind to metal binding regions in a biological species. Accordingly, metal ions contemplated for use in the methods include those described in United States Patent Application 20030068446 such as ruthenium, cobalt, rhodium, rubidium, vanadium, cesium, magnesium, calcium, chromium, molybdenum, aluminum, iridium, nickel, palladium, platinum, iron, copper, titanium, tungsten, silver, gold, zinc, zirconium, cadmium, indium, and tin.

### III. Surface Functionalization

### A. Compounds

Metal ions are coordinated on the surface through interaction with one or more functional groups on the surface. In general, the functional groups are applied to the surface, but the methods also embrace use of a surface which inherently includes functional groups, i.e., the functional groups need not be applied to the surface. In embodiments wherein the functional groups are not inherent, a compound having functional groups capable of metal ion coordination is applied to the surface. The compound is, in one aspect, randomly and/or completely applied to the surface, and in other aspects, the compound is applied to the surface in a pattern. Patterned application of the compound permits, when desired, a more controlled coordination of the metal ion, and therefore more controlled immobilization of the biological species. In the instance of producing a biological implant, controlled immobilization of the biological species may or may not be desired. In embodiments wherein immobilization of two or more biological species is desired, for example at discrete locations, controlled immobilization is achieved by way of a specific patterning on the surface.

The compound, in various aspects, includes carboxylic acid, phosphate sulfur, and/or nitrogen functional groups, which associate with one or more metal ions, and a functional group which interacts with the surface. In one aspect, the functional group which interacts with the surface is a thiol group. This type of interaction is, in various aspects, covalent or non-covalent.

The examples herein exemplify the use of an alkanethiol substituted with a carboxylic acid functional group, however, the worker of ordinary skill will appreciate that this class of compound can be substituted with any of a number of other compounds with the same or similar functional groups that provide the same or similar surface and metal ion interactions. In certain instances, the choice of compound depends on the type of surface and/or substrate. For example, when using a glass surface, use of a siloxane is contemplated. In methods using a substituted alkanethiol, the alkanethiols used are linear and branched alkanethiols having a carbon chain length of from C8 to C22. Linear alkanethiols have, in certain aspects, a chain length of from C8, C9, C10, C11, C12, C13, C14, C15, C16, C17, C18, C19, C20, C21 or C22. Alkanethiols which may be mentioned are carboxylic acid substituted forms of n-decanethiol, n-dodecanethiol, tert-dodecanethiol, n-tetradecanethiol, n-pentadecanethiol, n-hexadecanethiol, n-heptadecanethiol, n-octadecanethiol, n-nonadecanethiol, n-eicosanethiol, n-docosanethiol.

Use of substituted alkanethiols, or any other compound, in mixtures is also contemplated for use ion the methods provided.

### B. Patterning

As discussed herein, in instances where the surface is functionalized, one or more functionalizing compounds is randomly and/or completely applied to the surface or is patterned on the surface. A random application has no discernable pattern, and a complete application covers the surface in substantially its entirety.

Application of the functionalizing compound in a pattern provides controlled coordination of metal ions on the surface at one or more desired locations. Any pattern is contemplated and its selection will depend on the desired placement of the ultimately immobilized biological species with consideration given to desired density, spacing, the biological species, however many, to be immobilized and alignment. Typical patterns include arrays, linear positioning, circular patterns, discrete spotting and the like.

Patterning of the surface is carried out using generally using lithographic techniques known in the art. Exemplary, and non-limiting, patterning techniques such as Dip-Pen Nanolithography (DPN) (Piner, et al., Science 1999, 283, 661-663, United States Patent Application Nos. 20030068446 and 20050009206) and μ-contact printing (U.S. Pat. No. 6,966,997) are described in details in the examples herein. Those of skill in the art will appreciate that pre-patterned surfaces are commercially available from, for example, ADTEK, Quebec, Canada, and that a number of other patterning processes can be employed as described in the background herein.

### IV. Surface Passivation

### A. Methods

In other embodiments, the methods also include use of a surface which has a “passivation” layer, or wherein the surface has been “passivated.” As used herein, the term “passivation” generally means the alteration of a reactive surface to a less reactive state. Passivation can refer to, for example, decreasing the chemical reactivity of a surface or to decreasing the affinity of a surface for a biological species. Stated differently, passivation is a method by which a surface is coated with a moiety having the ability to block subsequent binding to the surface at points where the moiety is bound. In general, a passivation step modifies the surface which is not patterned in order to eliminate or reduce non-specific binding directly to the surface, which can in certain instances be irreversible. Passivation is therefore a means by which binding of a biological species can be controlled. To the extent that binding of the biological species is not irreversible, passivation permits using the same surface several times, thus, in one aspect, immobilization of a variety of biological species is achieved using a surface which has been passivated. In some embodiments, a passivation agent is in the form of a monolayer wherein the monolayer of passivation agents is tightly packed in a uniform layer on the surface, such that a minimum of “holes” exist. Surface passivation methods are described in United States Patent Application 20050029678, United States Patent Application 20040209269, United States Patent Application 20040023293, United States Patent Application 20030068446 and United States Patent Application 20020132371.

### B. Passivation Agents

Passivation agents include any material that does not bind to the biological species being immobilized. Exemplary agents include, but are not limited to silicon oxide, silicon dioxide, silicon nitride, silicon oxy-nitride, an organic film such as polyamide, a metal having a thin layer of oxidation (e.g., oxidized aluminum) and compounds containing sulfur groups (e.g., thiols, sulfides. Still other passivation agents used in methods provided alkanethiols as described above but without a substituted with a carboxylic acid functional group. In methods using an alkanethiol as a passivation agent, the alkanethiol is linear or branched, having a carbon chain length of from C 8 to C 22. Linear alkanethiols have, in certain aspects, a chain length of from C8, C9, C10, C11, C12, C13, C14, C15, C16, C17, C18, C19, C20, C21 or C22. Alkanethiols which may be mentioned are carboxylic acid substituted forms of n-decanethiol, n-dodecanethiol, tert-dodecanethiol, n-tetradecanethiol, n-pentadecanethiol, n-hexadecanethiol, n-heptadecanethiol, n-octadecanethiol, n-nonadecanethiol, n-eicosanethiol, n-docosanethiol. Use of alkanethiols in mixtures is also contemplated for use in the methods provided. Also, alkanethiols contemplated for use include poly- or oligo-ethyleneglycol thiol (Pale-Grosdemange et al., J. Am. Chem. Soc. (1991) 113:12-20).

### V. Surfaces

Methods provided embrace the use of any surface that either is functionalized in itself or can be functionalized for purposes of coordinating metal ions. The choice of the surface depends on the intended use of the immobilized biological species product of the method. For example, in instances where the product of the method is a biological implant, consideration is given to immunoreactivity of the surface, as well as its stability and biodegradability. For in vitro use of the method and the resulting product, these considerations are of less importance, however, stability may be important if the immobilized product will be maintained over an extended length of time.

In one embodiment, the surface is a thin film, and in various aspects, the thin film is metallic. Methods provided thus embrace use of a thin film of silver, gold, copper, aluminum, nickel, titanium, silicon oxide (glass) and polymers such as polystyrene.

### VI. Substrates

As used herein, a “substrate” is any material that supports the surface for immobilizing the biological species. In general, the substrate itself is inert in that it is incapable of specifically binding the biological species or immobilizing a metal ion alone, i.e., the substrate itself does not have functionalized surface. In one aspect, relatively smooth substrates are utilized which provide for subsequent high resolution printing. Substrates can be cleaned and used soon after cleaning to prevent contamination. In other aspects, the substrate is one that has been treated with one or more adsorbates. In still other aspects, the substrate is a micro- or nanoparticle, a fiber, a foam, or a mesh. Depending on the surface area desired, the substrate varies, at one extreme, from being non-porous and smooth to porous and rough at the other extreme. The worker of ordinary skill will appreciate that the degree of porosity and/or roughness of the substrate surface will determine the surface area available.

Substrates used in the methods embrace, for example, those described in United States Patent Application No. 20050009206 and include an insulator such as, for example, glass or a conductor such as, for example, metal, including gold. In other aspects, the substrate is a metal, a semiconductor, a magnetic material, a polymer material, a polymer-coated substrate, or a superconductor material. Still further, examples of suitable substrates include but are not limited to, ceramics, metal oxides, semiconductor materials, magnetic materials, polymers or polymer coated substrates, superconductor materials, polystyrene, and glass. Metals include, but are not limited to gold, silver, aluminum, copper, platinum and palladium. Other substrates onto which compounds may be patterned include, but are not limited to silica, silicon oxide, GaAs, and InP. Still other exemplary substrates are described in United States Patent Application 20030068446 and include those comprising silicon, silicon oxide, silicon dioxide, silicon nitride, Teflon, alumina, glass, sapphire, a selinide, or polyester. Still other exemplary substrates in those made out of sapphire, quartz, nitrides, arsenides, carbides, oxides, phosphides, selinides or plastics. Still other substrate materials include Al₂O₃, ZrO₂, Fe₂O₃, Ag₂O, Zr₂O₃, Ta₂O₅, zeolite, TiO₂, glass, indium tin oxide, hydroxyapatite, calcium phosphate, calcium carbonate, Au, Fe₃O₄, ZnS, CdSe or a mixture thereof. An organic biocompatible carrier material may be materials such as polypropylene, polystyrene, polyacrylates or a mixture thereof.

In one embodiment, the substrate consists of or comprises a biodegradable material. The biodegradable material is stable for the period of use, but may thereafter be degraded to result in excretable fragments. These are in particular polyesters of polylactic acid which have been additionally stabilized by crosslinking and are biodegradable in a controlled fashion. Exemplary substrates of this type include without limitation a polyester of polylactic acid and in particular, poly(D,L-lactic acid-co-glycolic acid) (PLGA).

The worker of ordinary skill will appreciate that combinations of the material, either described in general or specifically disclosed, are contemplated for use as a substrate as long as the combination possesses the desired properties.

### VII Products

In another aspect, complexed products of the methods described herein are provided, comprising a biological species immobilized on a surface. As described above for the methods provided, in one aspect the complex comprises a surface, one or more types of metals ion coordinated on the surface, and a biological species associated with one or more of the coordinated metal ions. In one embodiment, the metal ions are coordinated directly on the surface, and in another embodiment, the complex further comprises a functionalized surface which permits indirect metal ion coordination on the surface. In still another aspect, any embodiment of the surface described herein is passivated in areas that are not occupied by coordination sites. In another aspect, the entire complex is supported on a substrate as described herein.

In another embodiment of the product, a surface is provided comprising one or more types of metal ion coordinated thereto. The metal ions are either coordinated directly on the surface or are indirectly coordinated on the surface through a functionalizing agent applied to the surface. In each aspect of this type of surface, a passivation layer is optionally included. In still another aspect, the surface is supported on a substrate as described herein.

In another embodiment, kit products are provided comprising a complexed product as described above and a container,

In another embodiment, a kit is provided comprising a surface as described above and a container. In one aspect, the kit further comprises a biological species as described herein which can be immobilized on the surface. The biological species is optionally included in a separate container in the kit.

### EXAMPLES

### Example 1

In a typical experiment, 12-mercaptododecylphosphonic acid (MDP) or 16-mercaptohexadecanoic acid (MHA, Aldrich, Milwaukee, Wis.) features were patterned on a gold thin film substrate (30 nm Au and 10 nm Ti adhesion layer on a silicon wafer, Silicon Sense, Inc.) by DPN or μ-CP (Scheme 1). Polycrystalline gold films were prepared by thermal evaporation of 10 nm of Ti on SiOₓ, followed by 30 nm of gold at a rate of 0.1 nm/s and a base pressure of <1×10⁻⁶ Torr. DPN-patterning experiments were carried out either an NScriptor™ DPN system (Nanoink, Inc. Chicago, Ill.) equipped with a 90 μm scanner, closed-loop can control, and commercial lithography software (Ink-CAD™, Nanoink, Inc, Chicago, Ill.) or with an atomic force microscope (AFM) (CP, Veeco/Thermomicroscopes, Sunnyvale, Calif.) equipped with a 100 μm scanner, closed-loop scan control, and commercial lithography software (DPNWrite™, DPN System-1, Nanoink Inc., Chicago, Ill.). Gold-coated commercial AFM cantilevers (sharpened, Si₃N₄, Type A, Nanoink Inc.) with a spring constant of 0.05 N/m were used for patterning and subsequent imaging. Commercially available gold-coated Si₃N₄ multicantilever A-26 arrays with a spring constant of 0.097 Nm⁻¹ were obtained from Nanoink. All DPN patterning experiments were carried out under ambient conditions (˜30% relative humidity, 24° C.). Tips were soaked in a 10 mM acetonitrile solution of MHA and then blown dry with N₂. MHA features were generated on a gold thin film substrate by traversing the tip over the surface in the form of the desired pattern.

For μ-contact printing, stamps were fabricated by placing a photolithographically prepared master (Photomask supplied by ADTEK, Quebec, Canada) in a glass Petri dish, followed by pouring a mixture of polydimethylsiloxane (PDMS, Sylgard 184, Dow Corning, Midland, Mich.) in a 10:1 (v:v) ratio of monomer to initiator over the master. After degassing the mixture for 1 h, the elastomer was cured overnight at 60° C. and then gently peeled from the master. After the stamp was dried, patterned structures were generated on the surface by bringing the stamp for 10 s (by hand) into contact with gold substrate, rinsing with ethanol and drying with N₂.

The regions surrounding these features were then passivated with 11-mercaptoundecyl-penta(ethylene glycol) (PEG-SH) (Pale-Grosdemange, et al, 3. Am. Chem. Soc. 1991, 113:12-20) by immersing the substrate in the alkanethiol solution (5 mM in ethanol) for 30 min followed by copious rinsing with ethanol. The passivation layer minimizes nonspecific binding of the proteins or virus particles to the unpatterned areas. The carboxylic acid groups of MHA were then coordinated to Zn(II) ions by exposing the substrate to an ethanolic solution of Zn(NO₃)₂.6H₂O (5 mM, 99%, Fluka, Milwaukee, Wis.) for 6 h followed by washing with ethanol. Similarly, phosphonic acid groups of MDP were coordinated to Zr ions by exposing the substrate to a solution of ZrOCl₂.8H₂O (5 mM in H₂O) for 6 h followed by rinsing with H₂O

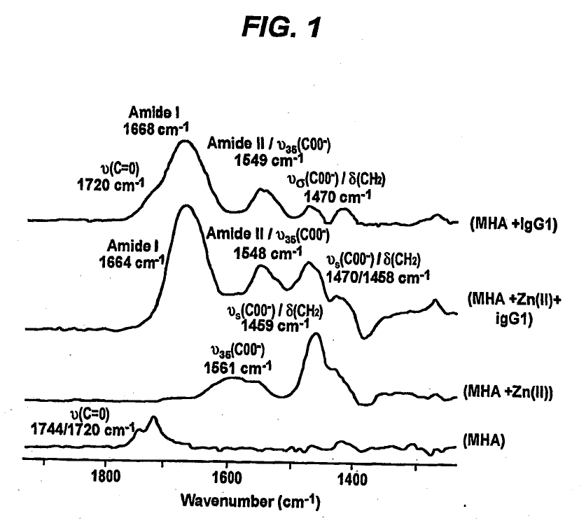

The functionalized substrates were finally exposed to a solution of the desired antibody (100 μg/mL) in phosphate-buffered saline (PBS, 10 mM with NaCl (0.15 M), pH 7) for 2 h at room temperature in an air-tight humidity chamber. Excess antibodies were removed by washing the substrates with PBS buffer. The antibody arrays were characterized by tapping-mode AFM (TM-AFM, taken with a Nanoman AFM system, Veeco Instruments) and polarization modulation-infrared reflection-absorption spectroscopy (PM-IRRAS) (see FIG. 1).

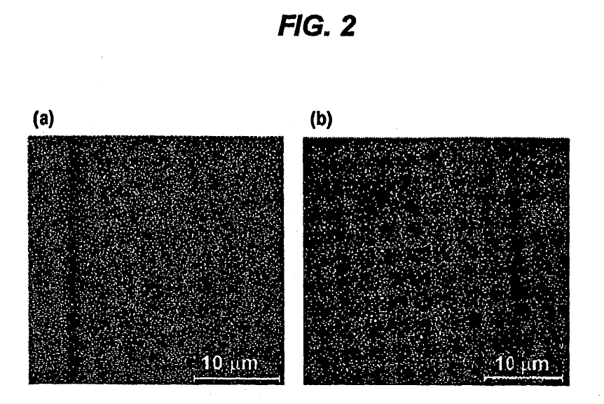

When Zn was utilized, the presence of Zn(II) metal ions before and after immobilization of antibodies was confirmed using time-of-flight secondary ion mass spectrometry (TOF-SIMS) (see FIG. 2). The immunoreactivity of immobilized antibodies was confirmed by an increase in AFM height profiles and fluorescence microscopy (Zeiss Axiovert 100A an optical microscope equipped with a Zeiss MRCS CCD camera, Thornwood, N.Y.) upon treatment with the appropriate antigens (proteins/virus particles) and fluorophore labeled antibodies.

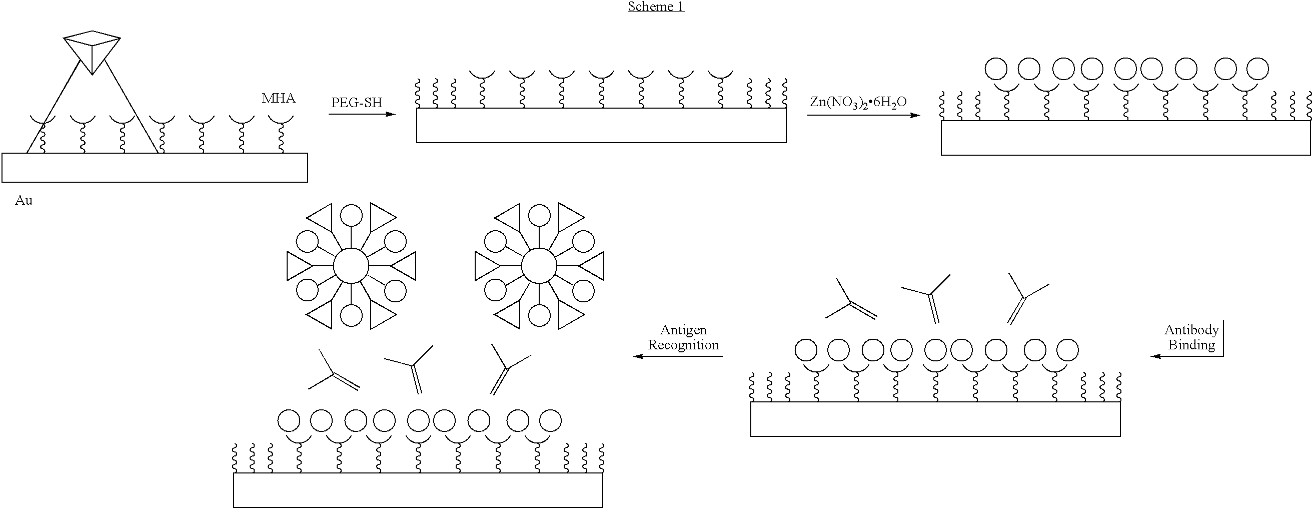

### Example 2

Immobilization of antibodies onto metal ion-modified arrays, was studied using a polyclonal goat IgG (anti-Udorn) that specifically recognizes proteins of influenza virus (A/Udorn/307/72) (H₃N₂), including the major surface antigen, hemagglutinin (HA). Anti-Udorn (polyclonal goat IgG) was purified from serum using an ImmunoPure (G) IgG Purification Kit (Pierce, Rockford, Ill.) according to the manufacturer's instructions. The antibody solution was then concentrated after dialysis, and aliquoted (1 mg/mL). Anti-SV5 (polyclonal rabbit IgG) was purified in a similar manner.

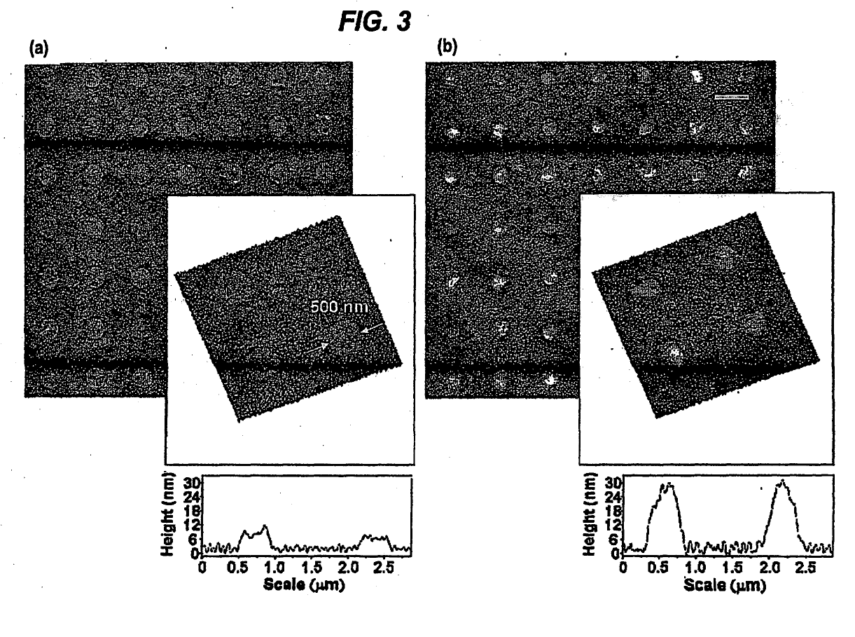

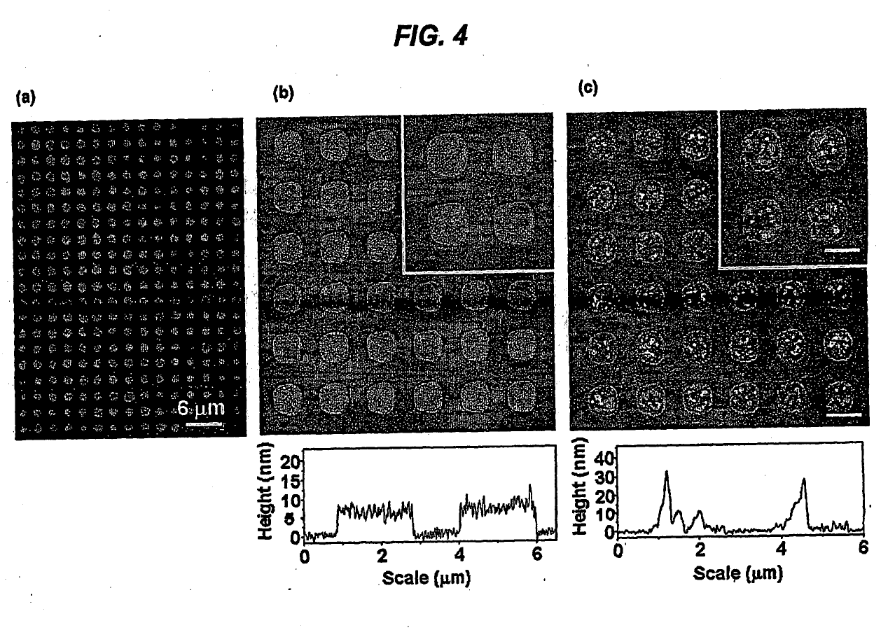

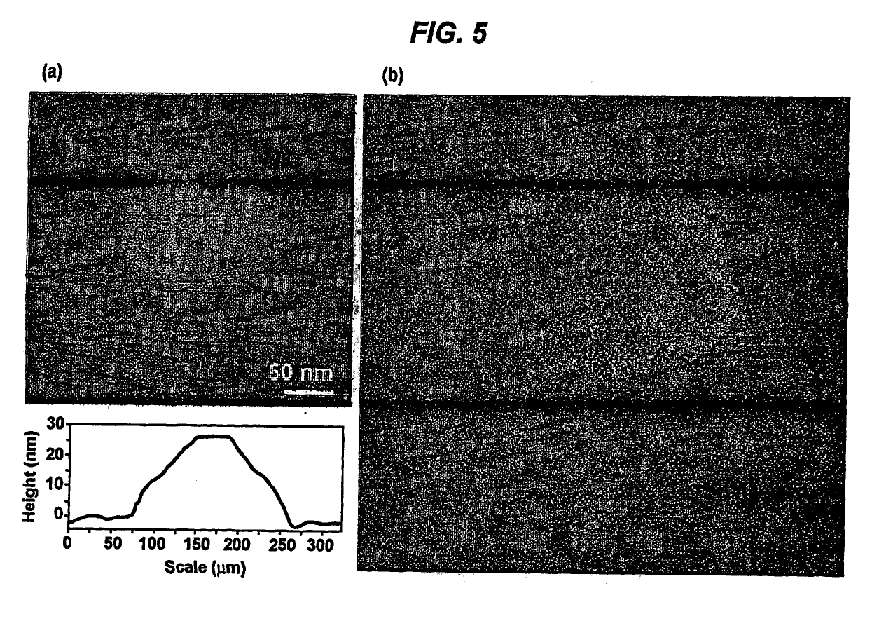

Micro- and nanoarrays of anti-Udorn immobilized through Zn(II) ions were generated as described above (see FIGS. 3, 4, and 5). The TM-AFM images of anti-Udorn nanoarrays confirm adsorption of the antibody and are consistent with the formation of a monolayer of antibodies (a uniform height of 6.5±1.0 nm is observed for each feature; the typical dimensions of an antibody are 8.5×14.5×4.0 nm) (Browning-Kelley, et al., Langmuir (1997) 13:343-350; Silverton, et la., Proc. Nat. Acad. Sci. USA (1977) 74:5140-5144). FIG. 3 shows images that were collected under ambient conditions where contraction of the antibody is expected (Peluso, et al., supra).

### Example 3

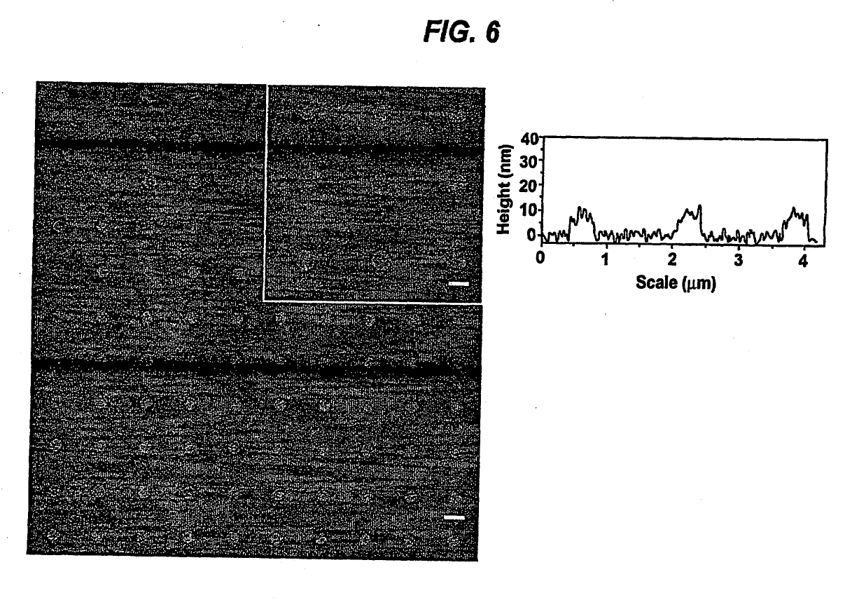

To evaluate the biorecognition properties of the immobilized anti-Udorn, the arrays were incubated for 2 h at 37° C. with a solution of purified influenza virus (A/Udorn/72) (Paterson, et al., in Molecular Virology: A Practical Approach, (Eds.: A. J. Davidson, R. M. Elliott) IRL Press, Oxford, 1993, pp. 35-73). Influenza A virus and paramyxovirus SV5 (as a negative control) virus particles were grown and purified as described (Paterson, et al., supra). The viral stock solutions were diluted into aliquots (approximately 5×10⁵ particles/A) and stored at −78° C. prior to use. Excess virus particles were removed by washing the substrates with PBS, Tween-20 solution (0.05%), and NANOpure water. TM-AFM imaging showed a height increase of 23±2 nm, consistent with virus particle assembly on the anti-Udorn features of the nanoarray (FIG. 3B and FIG. 6).

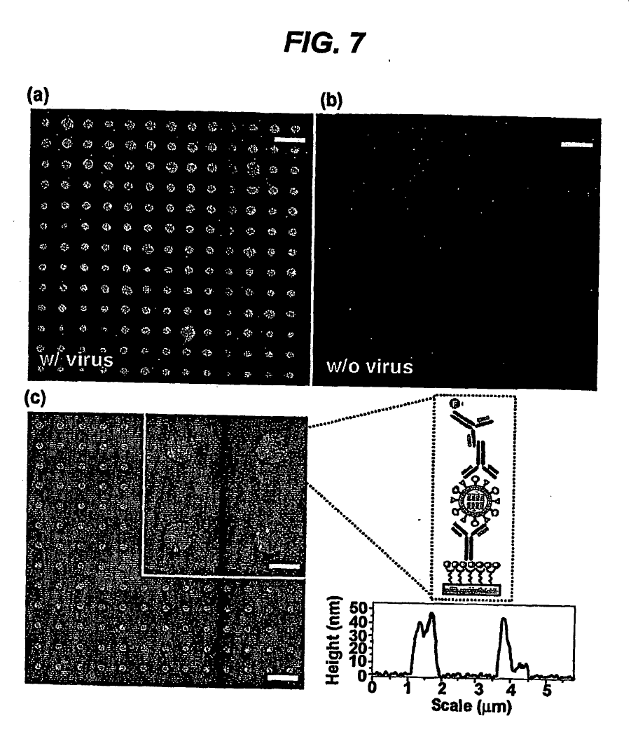

In addition, the virus attachment was also screened using fluorescence microscopy. For these studies, an array of anti-Udorn with captured influenza virus particles was treated with anti-HA (mouse IgG1, 12CA5, Covance Inc., Berkeley, Calif.) for 1 h at 37° C. to form a sandwich complex, followed by the addition of a fluorophore labeled secondary goat anti-mouse polyclonal IgG (Alexa Fluor 488, Covance Inc., Berkeley, Calif.) for the same amount of time. Excess antibodies were removed using the washing conditions as previously described. When arrays are treated with virus particles, green fluorescence is observed on the features (FIG. 7A). However, when the array is not treated with the virus solution, only background signal is observed (FIG. 7B). These substrates were also measured with TM-AFM, and a height increase of approximately 15.1±2.3 nm in one instance and 8.1±1.1 nm was observed upon formation of the sandwich complex, which is consistent with both antibodies binding onto the captured virus particles (FIG. 7C).

### Example 4

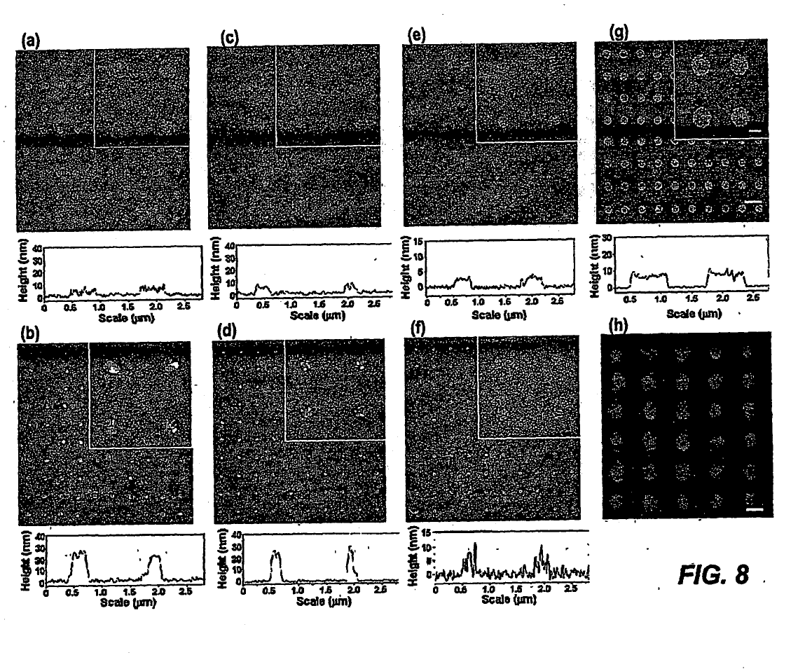

The generality of the metal-ion mediated immobilization scheme was studied with a series of different antibody subclasses that have high, low or no affinity for proteins A, G, A/G or L. Polyclonal chicken IgY (anti-HA, YPYDVPDYA [influenza HA-epitope], US Biological, Swampscott, Mass., in PBS 0.1% Tween 20), polyclonal rabbit IgG (anti-SV5), monoclonal mouse IgM (anti-estrogen receptor 13 (ER-13), Sigma-Aldrich, Milwaukee, Wis.), and monoclonal mouse IgG1 (anti-p24, Fitzgerald Industries Inc., Concord, Mass.) antibodies were assembled on nanoscale metal ion-based affinity templates, exhibiting height increases of 5.8±1.3 nm, 8.0±1.2 nm, 2.8±0.5 nm, and 7.8±1.1 nm respectively (FIG. 8).

Anti-ER-β (IgM) is an interesting case because it is a pentamer in which the five antibody subunits are connected through disulfide linkages in their F_{c} regions. IgM antibodies are immobilized here in a flat form through the F_{c} regions of the subunits, and hence the smaller apparent height of the features as compared with the other antibodies. The biological recognition of the antibodies was probed by incubating the arrays in solutions of their corresponding antigens for 2 h at 37° C. A comparison of the AFM images of all antibody arrays before and after incubation with their corresponding antigen solutions shows antigen binding.

Indeed, the height increases of 29±1 nm and 24±2 confirm that both mouse IgG1 and chicken anti-HA IgY recognize influenza virus particles (FIG. 8A), whereas a height increase of 25±2 nm shows that the immobilized anti-SV5 binds to SV5 particles (FIG. 8B). Similarly, anti-ER-β nanoarray features recognize estrogen receptor β (10 μg/mL, Sigma-Aldrich, Milwaukee, Wis.) as confirmed by a height increase of 5.6±1.5 nm (FIG. 8C).

Fluorescence microscopy also confirmed the presence of fluorescein-labeled HIV-1 p24 (50 μg/mL, Fitzgerald Industries Inc., Concord, Mass.) on anti-p24 nanoarrays (Lee, et al., Nano Lett. (2004) 4:1869-1872) immobilized through metal ion affinity templates (FIG. 8D). Similarly, immobilized influenza virus on a mouse IgG1 array was first treated with the same mouse IgG1 and second with a fluorescence labeled (Alexa Fluor 488, green) secondary goat anti-mouse IGG. The green fluorescence from the nanoarrays clearly indicated that successful binding of the influenza virus particle on the active antibody nanoarray.

### Example 5

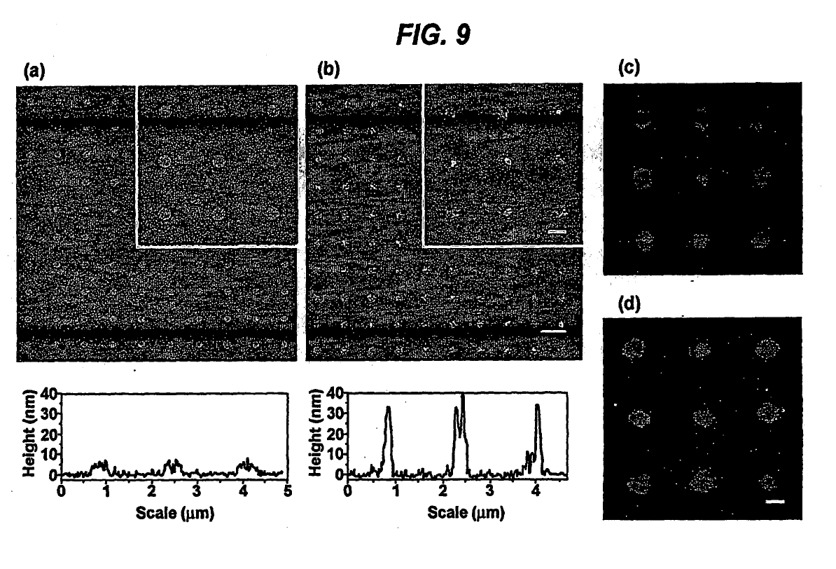

The specificity of our metal-ion immobilized methodology was also tested by exposing an anti-SV5 nanoarray to a solution of tobacco mosaic virus (TMV), a rod-shaped virus that is approximately 300 nm in length and 18 nm in diameter. A comparison of the TM-AFM images of the arrays before and after treatment with a solution of TMV (100 μg/mL, American Type Culture Collections, MA)) using the same conditions as before shows no evidence of virus binding to the immobilized antibodies or any of the exposed Zn(II) metal ions on the patterned area, despite the fact that TMV shows an affinity for Zn(II) (FIG. 9A) (Vega, et al., supra). Moreover, when a mixture (1:1) of the SV5 and TMV virus particles was incubated with anti-SV5 nanoarrays, only SV5 particle recognition took place on the entire array, as confirmed by TM-AFM images (FIG. 9B). This result supports the hypothesis that the Zn(II)-antibody features are homogeneously covered with SV5 and indicates that many of the immobilized antibodies are in an active state that results in immunoreactivity.

The ability to sort and detect multiple antigens on the same substrate was also confirmed using this metal-ion approach with negligible cross-reactivity (FIGS. 9C and 9D). Following the aforementioned method, we first created a microarray of metal ion-based affinity templates using μ-CP and the Zn method. One side of the array was then immersed in a solution of anti-cholera toxin (mouse IgG1 (100 μg/mL), Biodesign International, Saco, Me.), whereas the other side was immersed in a solution of anti-trypsin inhibitor from soybean (rabbit IgG (100 μg/mL), Biodesign International, Saco, Me.) for 2 h at room temperature. Excess antibody was removed by rinsing the substrates with PBS. The substrate was incubated with a 1% BSA solution in PBS for 30 min to block any unreacted sites on the array. The entire substrate was then challenged with a 1:1 solution of the corresponding fluorophore-labeled antigens (Alexa Fluor 594-labeled cholera toxin subunit B and Alexa Fluor 488-labeled trypsin inhibitor from soybean, Molecular Probes, Eugene, Oreg. (100 μg/mL in PBS)) for 1 h at 37° C. After rinsing the substrate with PBS, fluorescence microscopy confirmed the specific attachment of labeled antigens to their respective antibody array with no observable cross-reactivity, demonstrating that Zn(II) immobilized antibodies retain their activity and antigen recognition capabilities.

### Example 6

An informative comparison is the activity of antibodies immobilized on MHA features with and without the metal ions. Direct coupling of antibodies to MHA is often used as a strategy for immobilizing antibodies. Interestingly, on the micron to macroscopic length scales, both strategies, in certain cases, will result in immunoreactive features. However, reducing the size of the features to nanoscopic dimensions shows the importance and increased efficiency of the metal-mediated route. For example, when nanoarrays of anti-SV5 were fabricated by DPN (feature size=300 nm) with and without the Zn(II) coordination complex layer and studied in the context of SV5 virus recognition and binding, the arrays without Zn(II) showed binding to less than 1% (two virus particles imaged per four hundred nanoscopic features (n=3)) of the features while those prepared with Zn(II) showed binding to over 95% of the features. Results from this experiment are consistent with the conclusion that Zn(II) facilitates the immobilization of the antibodies in a uniform and immunoreactive state, and shows that the conventional approach of direct adsorption without Zn(II) can immobilize the antibodies, but often in a biologically inactive state. If a small amount of the antibody is immobilized in the active state, some virus binding will take place, but as the features are reduced in size, the probability of finding features with antibodies in the proper orientation decreases significantly and binding no longer takes place. Therefore nanoarrays allow one to readily observe the inefficiency of the immobilization chemistry in the Zn(II)-free case.

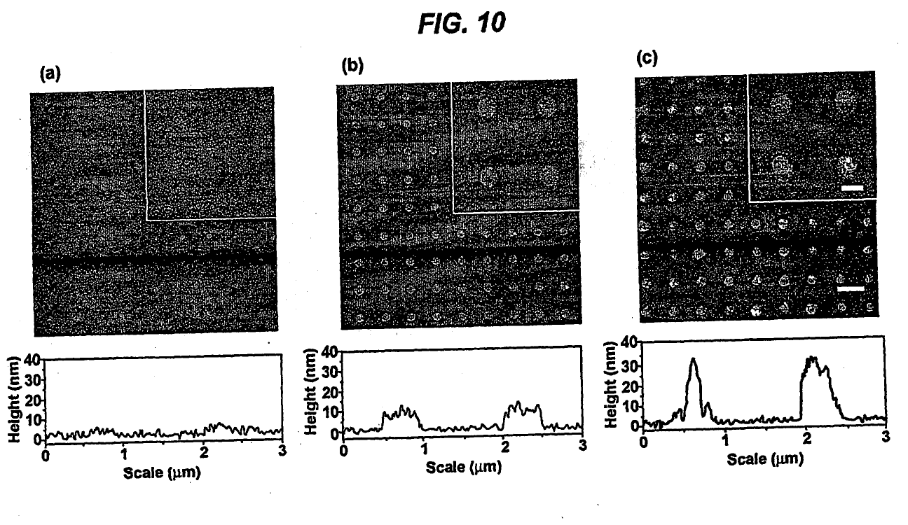

These experiments were also repeated with anti-Udorn on MHA to capture influenza virus particles, and similar results were obtained (data not shown). On the other hand, a similar experiment was also done using protein A/G to immobilize anti-Udorn to capture influenza virus particles, and comparable results were obtained with those prepared via the Zn(II) mediated approach (see FIG. 10). Therefore, nanoarrays allow one to readily observe the efficiency of different types of the immobilization methods, and suggest that for the majority of antibodies studied the activities of the immobilized antibodies are comparable to the protein A/G route. Interestingly, the Zn (II) ion approach allows one to immobilize IgY and IgM in active states. These antibodies, according to other researchers, cannot be immobilized by protein A/G.

### Example 7

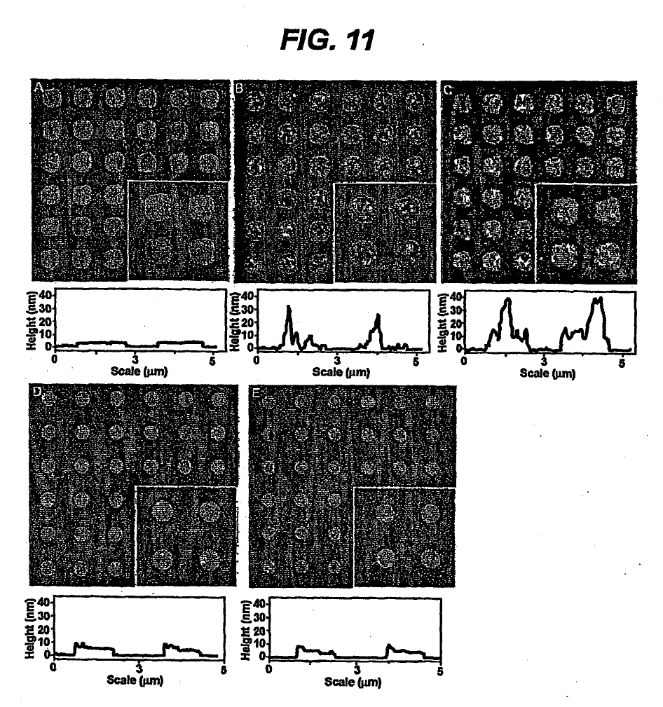

The immobilization and orientation of an antibody was afforded through the use of metal ions. As a proof-of-concept, microcontact printing (μ-CP) was used to generate circular features of 1.5 μm in diameter composed of 16 mercaptohexadecanoic acid (MHA) spaced at 1 μm apart on gold substrates. The terminal carboxylic acid groups of MHA were used to coordinate the metal ion (in this case Zn⁺²) by exposing the substrate to 5 mM ethanolic solution of Zn(NO₃)₂±6H₂O for 6 h, followed by rinsing with copious ethanol to remove any unbound metal ions from the surface. The metal ion arrays were then exposed to a solution containing unmodified antibody (anti-Udorn; 1 mg/mL in 0.15 M NaCl and 10 mM phosphate buffer at pH 7) specific to the viral surface protein spikes of the Influenza A (Udorn/307/72/H₃N₂) virus for 3 hours at room temperature (FIG. 11A).

If the antibody is in the proper orientation, the height obtained from a tapping mode atomic force microscope (TM-AFM) image should be approximately 6.5±0.9 nm (Lee, et al., Science (2002) 295:1702). When metal ions are used for immobilization, the average height of the Zn²⁺-IgG complex is 5.5 nm. To show that the active regions of the antibody (F_{ab}) are facing the proper orientation, the Influenza A virus was incubated with the Zn⁺²-antibody arrays for 2 hours at 37° C. (FIG. 11B). The average height of the arrays significantly increases by 26-28 nm indicating the presence of viral particles. The chemical identity of the surface-immobilized virus particles was additionally confirmed by treatment with the highly specific anti-Udorn to create a sandwich-type complex (FIG. 11C). The resulting height increase of 7-9 nm matches with that of the antibody. These experiments suggest that native antibodies can be immobilized into the proper orientation without loss of biorecognition properties on a carboxylic acid-metal ion terminated surface. The control experiments performed in the absence of Zn²⁺ and exposed to influenza A viruses did not feature any virus binding onto the pattern (FIGS. 11 and 11E).

### Example 8

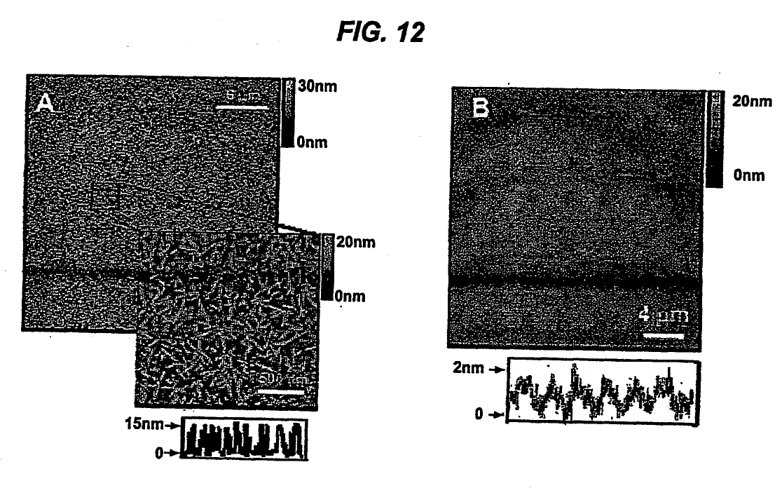

The use of metal ions to directly immobilize larger protein structures, such as viruses, was also demonstrated. Again, carboxylic acid-Zn⁺² modified surfaces was used to immobilize the unmodified viruses. Tobacco Mosaic Virus (TMV) was first used to demonstrate this concept. The steps to modify the surface were kept the same as above. A 100 μg/mL solution of TMV was incubated with the metallated surface for 4 h at room temperature. The substrates were washed with PBS and water to remove any unbound viruses. TM-AFM image illustrates the high binding affinity and coverage of the TMV viruses on the metal ion modified surface (FIG. 12A). The average height of the virus is 16±1 nm, which is consistent with the height reported in the literature (Maeda, Langmuir (1997) 13:4150).

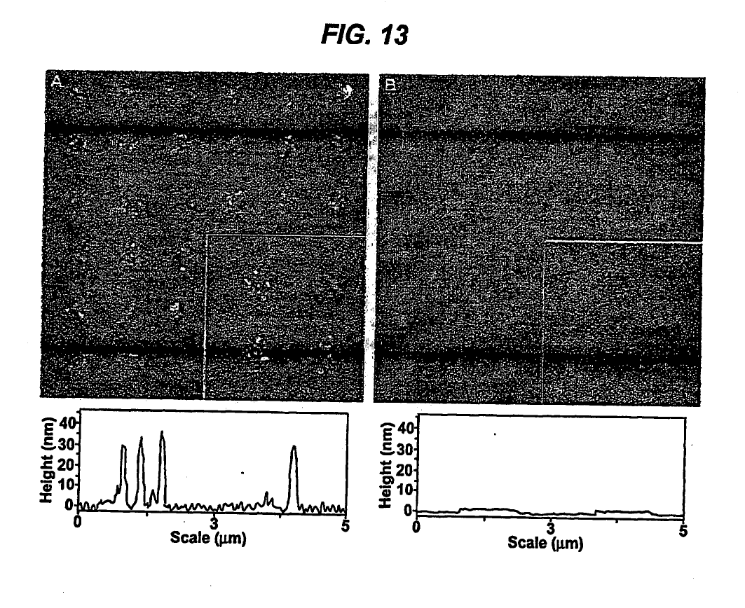

This protocol has also been extended for immobilizing Influenza A virus (FIG. 13A), and obtained an average height increase of 29±4 nm upon surface immobilization. The control experiments performed in the absence of Zn²⁺ and exposed to Influenza A viruses did not feature any virus binding onto the pattern (FIG. 13B).

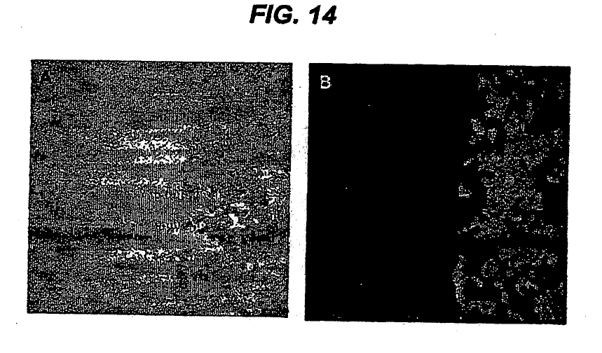

Use of this method has also been extended for investigating site-selective cell adhesion and cell proliferation. 2-μm diameter MHA dot arrays were generated with μ-CP and modified with Zn²⁺ as described above. The Zn²⁺-carboxylate patterns were then exposed to 30 pa, of MDCK cell solution (8.3×10³ cells) for 1 h, and then incubated in the cell media for over 1 h at 37° C. The surface was then washed off with PBS buffer and water to remove any unbound cells. The microscopy images clearly revealed the boundary between passivative/non-adhesive layer (1-mercaptoundecan-11-yl-penta(ethyleneglycol)) and metalated μ-CP patterns and indicated that the cells were selectively adhered only to the patterned area (FIG. 14).

All of the above U.S. patents, U.S. patent application publications, U.S. patent applications, foreign patents, foreign patent applications and non patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention.

What is claimed is:

1. A method of immobilizing a material on a surface, said material having a metal ion binding site, said surface having a plurality of coordination sites and a metal ion positioned on said coordination sites, said method comprising the step of contacting said material with said surface under conditions that permit said metal ion binding site on said material to associate with said metal ion on said surface.

2. The method of claim 1 wherein the material is an unmodified biological species selected from the group consisting of a protein, a polypeptide, a polysaccharide, a cell, a bacterium, a virus, a mold, and a fungus.

3. The method of claim 1 wherein said metal ion binding site on said material comprises carboxylate groups.

4. The method of claim 1 wherein said metal ion binding site on said material comprises imidazole groups.

5. The method of claim 1 wherein said metal ion is a divalent metal ion.

6. The method of claim 5 wherein said divalent cation is selected from the group consisting of zinc, copper, nickel, cobalt, iron, and manganese.

7. The method of claim 1 wherein the metal is selected from the group consisting of titanium and zirconium.

8. The method of claim 2 wherein said cell, bacterium or virus immobilized on said surface is viable.

9. The method of claim 2 wherein said protein or said polypeptide comprises an imidazole-rich region of an antibody Fc region.

10. The method of claim 2 wherein said protein or said polypeptide comprises an carboxylate-rich region.

11. The method of claim 9 wherein said protein is an antibody comprising and F_{c} region and an F_{ab} region.

12. The method of claim 11 wherein said antibody is immobilized on said surface predominantly oriented such that said F_{c} region is coordinately bound to said surface and said F_{ab} portion is disposed away from said surface.

13. The method of claim 9 wherein said protein is a chimeric antibody.

14. The method of claim 9 wherein said protein is a fusion protein comprising all or part of an antibody Fc domain and binding partner protein.

15. The method of claim 1 wherein said protein comprises a metal binding motif.

16. The method of claim 1 wherein said surface is a thin film.

17. The method of claim 1 wherein said surface is a nanoparticle.

18. The method of claim 1 wherein said surface is a nanoparticle on an otherwise inert surface.

19. The method of claim 1 wherein said surface overlays a substrate.

20. The method of claim 1 wherein said surface is patterned to control position at which the metal ion is coordinated.

21. The method of claim 20 wherein said surface is patterned using Dip-Pen Nanolithography.

22. The method of claim 20 wherein said surface is patterned using micro-contact printing.

23. The method of claim 1 wherein portions of said surface comprising coordination sites are defined by patterning.

24. The method of claim 1 wherein a chemical entity comprising one or more coordination sites is deposited on the surface in a spatially defined manner by means of Dip-Pen Nanolithography (DPN).

25. The method of claim 1 wherein a fraction of the coordination sites are masked or deactivated in a spatially defined manner by the use of Dip-Pen Nanolithography (DPN) to deposit a masking or deactivating agent on said surface such that said agent contacts said fraction of the coordination sites.

26. The method of claim 20 wherein said surface is patterned with an alkanethiol.

27. The method of claim 20 wherein said alkanethiol comprises functional group selected from the group consisting of a carboxylic acid, a phosphate, a sulfur or a nitrogen.

28. The method of claim 20 wherein said surface is patterned with 16-mercaptohexadecanoic acid (MHA).

29. The method of claim 20 wherein said metal ion is coordinated on said patterned surface in an array.

30. The method of claim 1 wherein said surface is passivated.

31. The method of claim 30 said surface is passivated with an alkanethiol.

32. The method of claim 31 wherein said alkanethiol is a poly- or oligoethylene glycol thiol.

33. The method of claim 31 wherein said alkanethiol is 11-mercaptoundecyl-penta(ethylene glycol) (PEG-SH).

34. The method of claim 1 wherein said surface is a gold thin film on a substrate.

35. The method of claim 34 wherein said substrate is silicon or glass.

36. The method of claim 34 wherein said substrate is a silicon wafer or glass slide.

37. The method of claim 1 wherein coordination sites of the surface are intrinsically present.

38. The method of claim 1 wherein coordination sites are introduced into the surface.

39. A surface having a plurality of coordination sites, a metal ion positioned on said coordination sites, and an unmodified material associated with said metal ion.

40. The surface of claim 39 wherein the material is an unmodified biological species selected from the group consisting of a protein, a polypeptide, a polysaccharide, a cell, a bacterium, a virus, a mold, and a fungus.

41. The surface of claim 39 wherein said metal ion binding site on said material comprises carboxylate groups.

42. The surface of claim 39 wherein said metal ion binding site on said material comprises imidazole groups.

43. The surface of claim 39 wherein said metal ion is a divalent metal ion.

44. The surface of claim 43 wherein said divalent cation is selected from the group consisting of zinc, copper, nickel, cobalt, iron and manganese.

45. The surface of claim 39 wherein said metal is selected from the group consisting of titanium and zirconium.

46. The surface of claim 40 wherein said cell, bacterium or virus immobilized on said surface is viable.

47. The surface of claim 40 wherein said protein or said polypeptide comprises an imidazole-rich region of an antibody Fc region.

48. The surface of claim 40 wherein said protein or said polypeptide comprises an carboxylate-rich region.

49. The surface of claim 47 wherein said protein is an antibody comprising and F_{c} region and an F_{ab} region.

50. The surface of claim 49 wherein said antibody is immobilized on said surface predominantly oriented such that said F_{c} region is coordinately bound to said surface and said F_{ab} portion is disposed away from said surface.

51. The surface of claim 47 wherein said protein is a chimeric antibody.

52. The surface of claim 47 wherein said protein is a fusion protein comprising all or part of an antibody Fc domain and binding partner protein.

53. The surface of claim 39 wherein said protein comprises a metal binding motif.

54. The surface of claim 39 which is a thin film.

55. The surface of claim 39 wherein said surface is a nanoparticle.

56. The surface of claim 39 wherein said surface is a nanoparticle on an otherwise inert surface.

57. The surface of claim 39, wherein said surface overlays a substrate.

58. The surface of claim 39, wherein said surface is patterned to control metal ion coordination.

59. The surface of claim 58, wherein said surface is patterned using Dip-Pen Nanolithography.

60. The surface of claim 58, wherein said surface is patterned using micro-contact printing.

61. The surface of claim 39 wherein portions of said surface comprising coordination sites are defined by patterning.

62. The surface of claim 39 wherein a chemical entity comprising one or more coordination sites is deposited on the surface in a spatially defined manner by means of Dip-Pen Nanolithography (DPN).

63. The surface of claim 39 wherein a fraction of the coordination sites are masked or deactivated in a spatially defined manner by the use of Dip-Pen Nanolithography (DPN) to deposit a masking or deactivating agent on said surface such that said agent contacts said fraction of the coordination sites.

64. The surface of claim 58 wherein said surface is patterned with an alkanethiol.

65. The surface of claim 58 wherein said alkanethiol comprises functional group selected from the group consisting of a carboxylic acid, a phosphate, a sulfur or a nitrogen.

66. The surface of claim 58 wherein said surface is patterned with 16-mercaptohexadecanoic acid (MHA).

67. The surface of claim 58 wherein said metal ion is coordinated on said patterned surface in an array.

68. The surface of claim 39, wherein said surface is passivated.

69. The surface of claim 68, wherein said surface is passivated with an alkanethiol.

70. The surface of claim 69 wherein said alkanethiol is a poly- or oligoethylene glycol thiol.

71. The surface of claim 69 wherein said alkanethiol is 11-mercaptoundecyl-penta(ethylene glycol) (PEG-SH).

72. The surface of claim 39 which is a gold thin film on a substrate.

73. The surface of claim 72 wherein said substrate is silicon or glass.

74. The surface of claim 72 wherein said substrate is a silicon wafer or glass slide.

75. The surface of claim 39 wherein coordination sites of said surface are intrinsically present.

76. The surface of claim 39 wherein said coordination sites are introduced into the surface.

77. A kit comprising the surface of claim 39.
